(19) United States
(12) Patent Application Publication
(10) Pub. No.: US 2005/0140352 A1
(43) Pub. Date: Jun. 30, 2005

(54) Method for detecting saturation in a current transformer

(76) Inventors: Rene Allain, Lunel (FR); Jean Philippe Puy, Sussargues (FR)

Correspondence Address: Thelen Reid & Priest, PO Box 640640, San Jose, CA, 95164-0640, US

(21) Appl. No.: 10/502,855

(22) PCT Filed: Jan. 23, 2003
(86) PCT No.: PCT/FR03/00220

(30) Foreign Application Priority Data
Jan. 29, 2002 (FR) 0201043

(51) Int. Cl. H01F 38/28

(52) U.S. Cl. 323/357

(57) ABSTRACT

The method is based on associating at least two saturation criteria for detecting a saturation phase when said criteria are satisfied simultaneously. It is characterized in that a first saturation criterion (C_{ε sat}) takes account of the calculation of an instantaneous prediction error (ε(Yₖ)) which is a function of the difference between the measured secondary current (i_{S}) and the secondary current (î_{S}) predicted with the aid of a mathematical model, and in that a second saturation criterion (C_{Φsat}) takes account of the instantaneous algebraic flux (Φₘₑₛ) calculated by integrating the sampled secondary current (Yₖ), comparing said algebraic flux to a positive threshold (S+, S′+) and to a negative threshold (S−, S′−). Said comparison is initialized with exaggerated probabilities of satisfying said second saturation criterion at the start of the measurement, in particular by overestimating (Φ_rem_high) the absolute value of the remanent flux of the transformer.

The invention relates to a method of detecting saturation in a current transformer, based on combining saturation criteria to detect a saturation phase if the criteria are satisfied simultaneously. The method employs digital processing of samples obtained by measuring the secondary current of the transformer and applying low-pass filtering to eliminate harmonics therefrom.

A conventional current transformer is generally assigned a permanent remanent flux, which flux is therefore present at the time of the first acquisition of a current measurement. This signifies that the secondary circuit of the transformer has retained a magnetic flux corresponding to the (possibly attenuated) last value of the flux of the current that was flowing in the secondary circuit at the moment a preceding measurement was interrupted. The phenomenon of remanence of the magnetic flux is well known in the art and is associated with ferromagnetic properties of the core of the transformer. A magnetic flux is an algebraic quantity and can therefore take positive and negative values.

The real value of the remanent flux affecting a current transformer is indeterminate, and the resulting uncertainty impacts on the estimate of the real flux which is calculated when measuring the secondary current of the transformer, as explained below. This uncertainty has finite limits, however: as a function of the characteristics of the transformer, and in particular of those advertised by the manufacturer of the instrument, extreme values can be defined for the remanent flux that are certain to bracket its real value. These extreme values, denoted Φ_rem_high and Φ_rem_low hereinafter, can be considered to have equal and opposite absolute values. It is obviously impossible for the real value of the remanent flux to be equal to one or the other of these extreme values simultaneously, but an equal probability must be considered for these two values in the absence of any previous measurement. As a precaution, and assuming that the remanent flux is equal to one of the extreme values, the absolute value of the remanent flux is over-estimated. As explained below, this precaution has the drawback of exaggerating the probability that the estimate of the real flux will depart excessively from the indeterminate real value of the flux, which causes serious problems for determining the presence of a saturation phase reliably from a flux measurement.

Note that absolute value of these two extreme values of the remanent flux can be defined as a particular percentage of a maximum value Sₘₐₓ of the current flux beyond which the linearity of the response of the transformer is no longer assured. This value Sₘₐₓ can be considered as a maximum flux threshold, and the equal and opposite value 5 min can be considered as a minimum flux threshold. Any current transformer can therefore be classified as a function of this threshold percentage. For example, a TPY class corresponds to a percentage of 20%, and the maximum value Φ_rem_high that the remanent flux of a TPY transformer can take is therefore equal to 20% of the maximum flux threshold Sₘₐₓ.

Referring to saturation of a current transformer amounts to the same thing as saying that the linearity of its response is no longer assured, and thus that the secondary current is no longer systematically proportional to the primary current, as is the case in the absence of saturation. Some portions of the secondary current signal are then more or less distorted, compared to the sinusoidal primary current. This loss of linearity of the response of the current transformer is due to the fact that the dimensions of its magnetic circuit are intentionally limited, mainly for economic reasons. It occurs if the absolute value of the magnetic flux in the secondary circuit exceeds the maximum flux threshold Sₘₐₓ referred to above, which happens in the following circumstances:
the appearance of an aperiodic component affecting the primary current of the transformer, and/or
a large increase in the amplitude of the primary current (in the case of a high symmetrical fault current), and/or
a high absolute value of the remanent flux, this factor generally tending to increase the risk of saturation, or sometimes to reduce that risk.

These factors, which cause saturation, will be better understood after reading the following description, in particular the explanations concerning the calculation of a current flux in a transformer.

Saturation causes serious problems in many systems using current transformers. For example, in a longitudinal differential busbar protection system, the measuring error of a current transformer during a saturation phase can cause unwanted tripping of the system. This can occur in the case of a fault (such as a short circuit) external to the area of busbars to which the system is assigned, which leads to unwanted opening of circuit-breakers protecting the area and therefore represents a constraint for the operator. It is then important to be able to detect as quickly as possible saturation of a transformer associated with the protection system, in order to inhibit tripping of the system during periods in which the secondary current of the transformer is serious distorted, compared to the primary current.

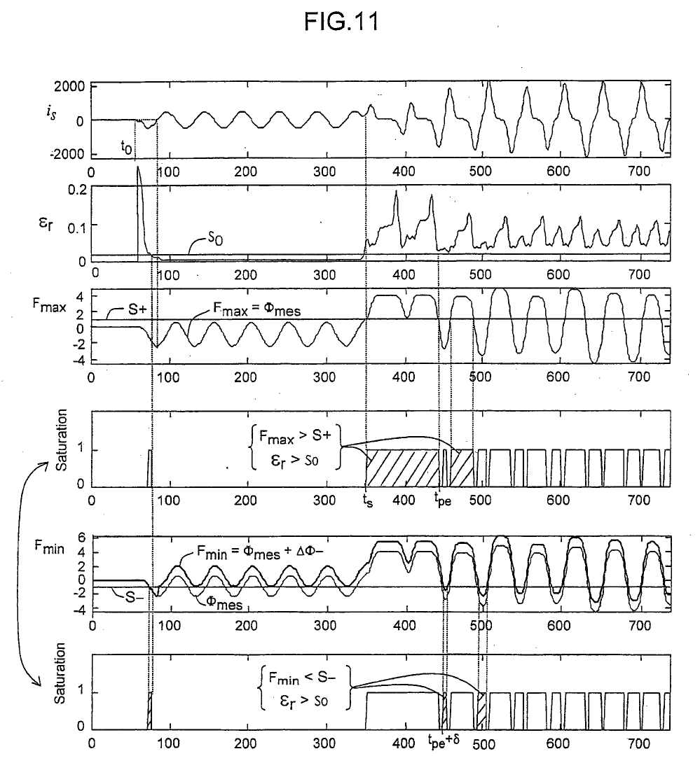

Nevertheless, if a relatively durable saturation regime is established, it is equally important to allow rapid tripping of the protection system in the event of a fault inside the area monitored by the system. The expression “relatively durable saturation regime” means a succession of closely spaced saturation phases, also referred to as saturation pulses hereinafter, extending over a period greater than the period of the primary current signal. FIGS. 11 and 12 represent saturation pulses. As previously explained, tripping of the protection system must be inhibited during a saturation pulse. It is therefore particularly desirable for the duration of a pulse to be as short as possible and for two consecutive pulses to be separated by a time interval corresponding to a non-saturation phase. During a non-saturation phase, the secondary current is approximately proportional to the primary current and the protection system is therefore fed with current measurements that are sufficiently reliable for the location of the fault to be determined.

An objective of most existing methods of processing the secondary current signal to detect saturation of the transformer is to be able to detect the start and the end of a saturation phase as quickly as possible, and consequently to be able to determine the saturation pulses with sufficient reliability when the transformer is operating in the saturated regime.

The patent document DE 3 938 154 discloses a method of detecting saturation using vector calculations on rotating current vectors. This method, and embodiments of it applied to a digital differential protection system, are described in more detail in the following publication: HOSEMANN G et al., “Modal saturation detector for digital differential protection”, IEEE Transactions on Power Delivery, New York, Vol. 8, No. 3, 1 Jul. 1993. The patent document EP 0 506 035 discloses a saturation detection method based on continuous determination of the absolute values of the secondary current and its derivative, which values are compared to appropriate threshold criteria to recognise high distortion of the secondary current signal if the criteria are satisfied simultaneously.

Note that the foregoing methods do not seek to reconstitute the primary current signal from the secondary current signal, unlike more recent methods, which necessitate extensive computation resources, such as the method described in U.S. Pat. No. 6,072,310.

An objective of the invention is to provide a reliable, powerful and economic method of determining saturation pulses during operation of a current transformer in a saturated regime. The method described hereinafter is particularly economical, in particular in terms of computation power, compared to other recent methods, because it does not necessitate reconstruction of the primary current signal. By enabling transformers to be specified having a lower performance rating than is usual, and operating them at the limits of their real performance, it also procures savings on the cost of the current transformers used in a protection system. Applied to current transformers in a longitudinal differential busbar protection system, the method according to the invention also has the objective of guaranteeing good stability of the differential protection system in the event of a fault occurring outside the area of surveillance of the protection system.

To this end, the invention provides a method of detecting saturation in a current transformer, based on associating at least two saturation criteria for detecting a saturation phase when said criteria are satisfied simultaneously, using digital processing of samples obtained by measuring and low-pass filtering the secondary current of the transformer to eliminate the harmonics therefrom, which transformer is subject to a remanent flux of indeterminate positive or negative value, characterized in that a first saturation criterion takes account of the calculation of an instantaneous prediction error which is a function of the difference between the measured secondary current and the secondary current predicted with the aid of a mathematical model, in that a second saturation criterion takes account of the instantaneous algebraic flux calculated by integrating the sampled secondary current, comparing said algebraic flux to a positive threshold and to a negative threshold, and in that said comparison is initialized with exaggerated probabilities of satisfying said second saturation criterion at the start of the measurement, in particular by overestimating the absolute value of the remanent flux of the transformer.

In an advantageous embodiment of the saturation detection method according to the invention a relative prediction error is calculated by establishing the ratio between the standard deviation of the absolute value of the instantaneous prediction error and the standard deviation of the absolute value of the measured current, and the first saturation criterion is satisfied as soon as said relative prediction error is greater than a given percentage.

In a complementary advantageous embodiment of the saturation detection method according to the invention the relative position of the algebraic flux with respect to a positive threshold and/or a negative threshold is corrected if said threshold is crossed by the algebraic flux in the absence of saturation, the correction consisting in particular of reducing at least the absolute value of an extreme value of the remanent flux. A saturation phase is established if at least one of said thresholds is crossed by the algebraic flux while the first saturation criterion is simultaneously satisfied.

The invention, its features and its advantages are explained in the following description, which is given with reference to the figures listed below.

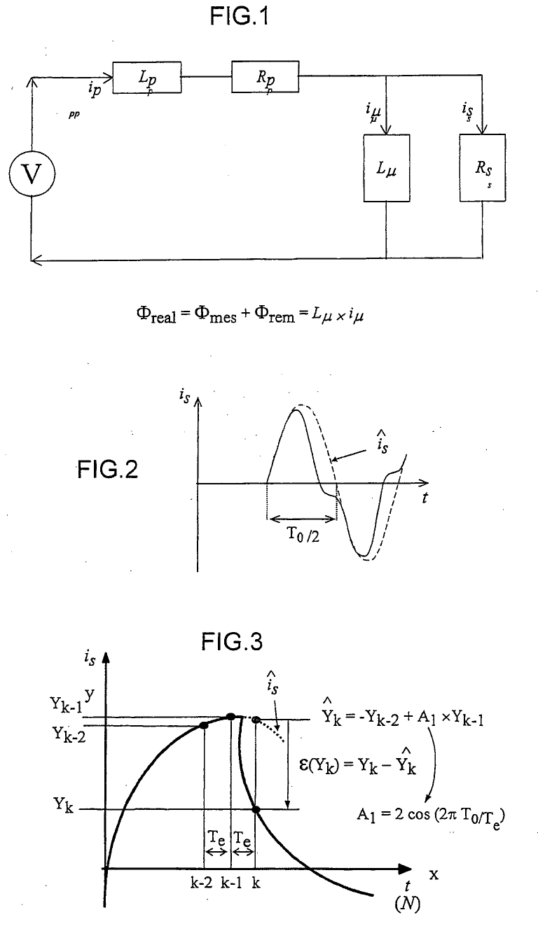

FIG. 1 represents a conventional electrical model of a current transformer.

FIG. 2 represents a saturated secondary current signal, showing the distortion relative to the predicted unsaturated secondary current signal.

FIG. 3 shows the sampling of a saturated secondary current signal and use of a mathematical model to compute the predicted unsaturated signal and the instantaneous prediction error.

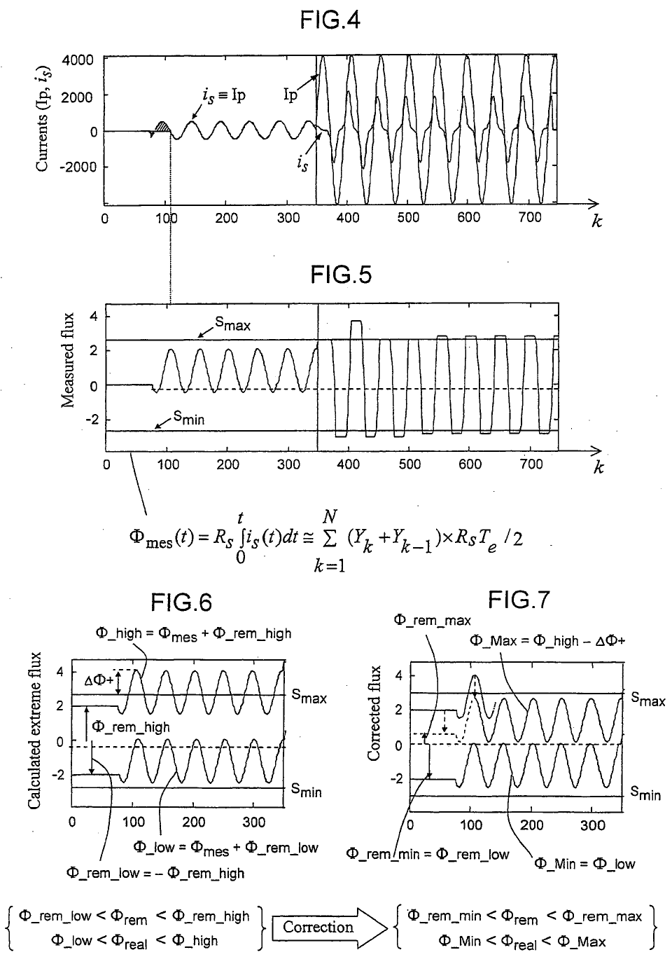

FIG. 4 shows sampled measurements of a secondary current signal superimposed on the corresponding primary current signal on passing from an unsaturated regime to a saturated regime.

FIG. 5 shows the variations in the measured instantaneous algebraic secondary current flux, which is calculated from sampled measurements of the secondary current signal represented in FIG. 4, and represents the saturation threshold Sₘₐₓ beyond which the linearity of the response of the transformer is no longer assured.

FIG. 6 shows the curves of two extreme fluxes that bracket the real instantaneous current flux, said extreme fluxes being calculated from the FIG. 5 algebraic flux, allowing for extreme values that bracket the remanent flux.

FIG. 7 represents the two extreme fluxes from FIG. 6, the continuous components of which have been corrected in the event of exceeding a saturation threshold outside a saturated regime of the transformer.

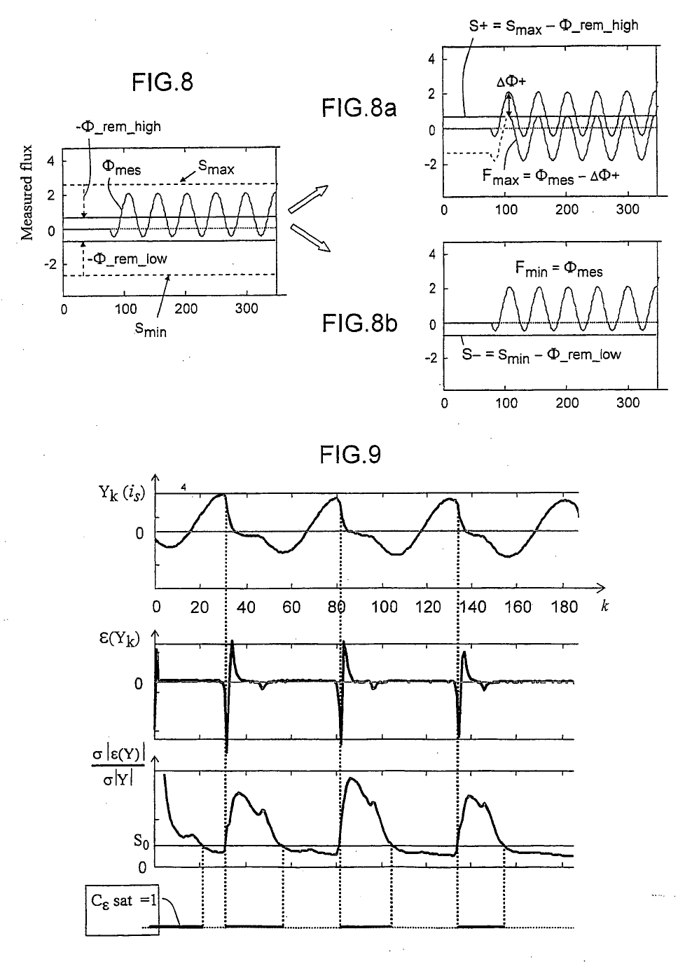

FIGS. 8, 8a and 8b show a method of flux comparison and correction outside the saturated regime, equivalent to that shown in FIGS. 6 and 7.

FIG. 9 represents simultaneously the sampled measurements of a saturated secondary current signal, a prediction error curve obtained from said measurements using the mathematical model shown in FIG. 3, the corresponding relative prediction error curve, and logic signals reflecting the verification of a saturation criterion.

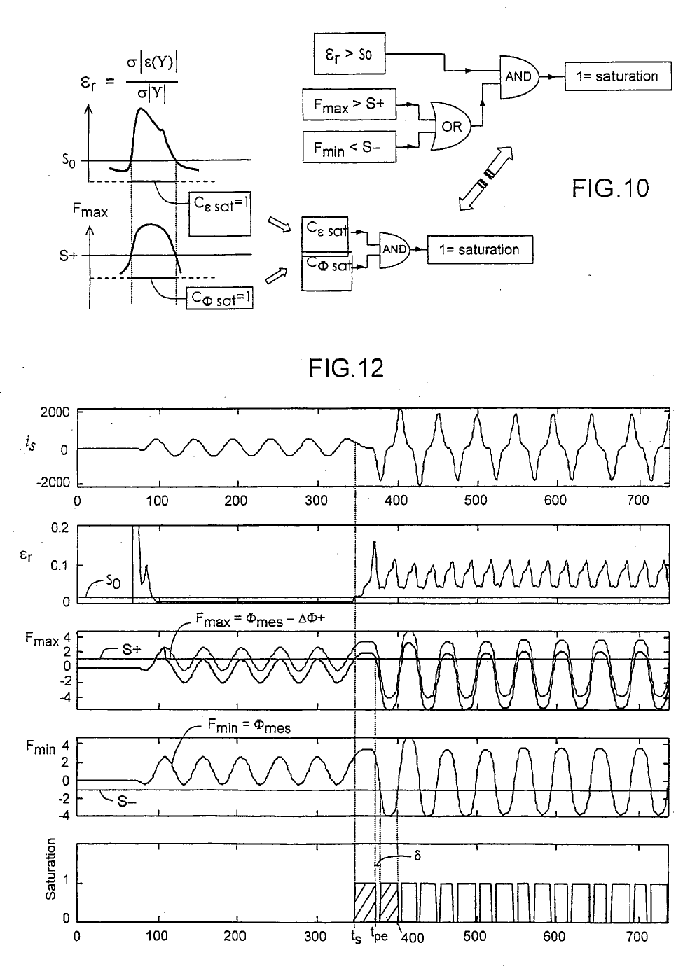

FIG. 10 is a diagram illustrating the method used by the invention to determine the saturation phases of a current transformer.

FIG. 11 represents graphically the use of the method employed by the invention to determine the saturation pulses of a transformer on changing from a normal regime to a saturated regime, as applied to a concrete example of sampled measurements of the secondary current of the transformer.

FIG. 12 represents graphically the use of the method employed by the invention, as applied to another example of sampled measurements of the secondary current of a transformer.

In FIG. 1, the conventional electrical model for any current transformer represented uses only the usual components, such as resistors and inductors. The primary of the transformer is characterized by its resistance Rₚ and its inductance Lₚ. A magnetizing inductance L_{μ} is present in the intermediate portion of the transformer. The secondary of the transformer is characterized by its resistance R_{S}. The input current present at the primary of the transformer is denoted iₚ and the output current available at the secondary is denoted i_{S}. A magnetizing current i_{μ} is also present in the intermediate portion of the circuit.

Assuming that the value Φᵣₑₘ of the remanent flux of the transformer is zero at the time at which a continuous measurement of the secondary current i_{S} begins, the instantaneous magnetic flux of the secondary current is by definition equal to Φₘₑₛ(t), which is measured by calculating the surface area of the secondary current as a function of time multiplied by the resistance R_{S} of the secondary. This calculation is described in detail later with reference to FIG. 5. However, because the remanent flux is generally different from zero, the value Φᵣₑₘ must be added to the measured flux to obtain the real instantaneous magnetic flux, as shown by the following standard equation:
Φᵣₑₐₗ(t)=Φₘₑₛ(t)+Φᵣₑₘ=L_{μ}×i_{μ}(t)

Accordingly, the remanent flux can be seen as a portion of the continuous component of the real flux, which explains why uncertainty as to the value of the remanent flux impacts on the estimate of the real flux.

FIG. 2 shows a saturated secondary current signal i_{S} over its fundamental period T₀, showing the distortion relative to the unsaturated signal î_{S} which can be predicted by sinusoidal extrapolation. Even in a saturated regime, there are brief phases of non-saturation, typically with a duration less than a quarter-period, during which the secondary current has a quasi-sinusoidal form and is therefore approximately proportional to the primary current. The greater the saturation of the transformer, the shorter these non-saturation phases. As previously indicated, it is particularly desirable for consecutive saturation pulses that are to be detected in a saturated regime of the transformer to be determined with sufficient accuracy to show as separate time intervals that correspond to these brief non-saturation phases.

In FIG. 3, a saturated secondary current signal is sampled with a sampling frequency 1/Tₑ to obtain a series of numerical values Yₖ coded on 16 bits, for example. It can be seen clearly that a very pronounced phase of saturation begins between the times respectively corresponding to the samples k−1 and k, which times are separated by a time period equal to the signal sampling period Tₑ. According to the invention, a value Yₖ of the unsaturated signal î_{S} for a sample k is predicted using a sinusoidal extrapolation mathematical model. The model is preferably based on a fixed coefficient second order auto-regressive method, but there is nothing to prevent the use of another method, or use of this method with an order higher than two if the available computation power allows it.

With an order equal to two, a value Ŷₖ depends on the value Ŷₖ₋₁ of the measured signal for the sample k−1 and the value Yₖ₋₂ of the signal measured for the sample k−2, in accordance with the following equation:
Ŷₖ=A₂×Yₖ₋₂+A₁×Yₖ₌₁

The fixed coefficients A₁ and A₂ are respectively equal to 2 cos(2πT₀/Tₑ) and −1, so that the above equation becomes:
Ŷₖ=2 cos(2πT₀/Tₑ)×Yₖ₋₁−Yₖ₋₂

In an advantageous calculation method, to limit the necessary calculation power, only the sample k that follows a measurement of a sample k−1 of the secondary current is predicted. It is therefore not possible to consider that one is reconstituting a current signal î_{S} from the signal i_{S} deteriorated by the saturation. As far as the applicant is aware, the above modeling method has never been used to predict a signal from values of a current signal truncated by saturation.

Predicting the value of a sample k that follows a measurement of a sample k−1 of the secondary current i_{S} is sufficient to define an instantaneous prediction error e(Yₖ) equal to the algebraic difference between the value Yₖ measured and the value Ŷₖ predicted for the sample k. The following equation therefore applies: e(Yₖ)=Yₖ−Ŷₖ, which reflects the fact that the instantaneous prediction error is a function of the difference between the secondary current i_{S} measured at a given time and the secondary current î_{S} predicted for that time using earlier measurements.

From the foregoing description it can be deduced that the prediction error is zero or virtually zero if the current transformer is not saturated and if the primary current is not disturbed at the time of the measurement. The secondary current i_{S} measured and the secondary current î_{S} predicted are then identical. Conversely, the prediction error will diverge from zero if a saturation phase or disturbance of the primary current occurs.

The occurrence of a saturation phase necessarily implies an increase in the absolute value of the prediction error, generally a sharp increase. This signifies that it is possible to be certain that there is no saturation if the absolute value of the prediction error is below a threshold close to zero. In practice, it is shown hereinafter that, to be able to define a threshold of this kind effectively, it is advisable to smooth the prediction error.

On the other hand, if the prediction error diverges from zero, this does not necessarily signify saturation of the transformer. In the event of a fault in the network around the transformer, a discontinuity can occur in the primary current signal of the transformer and impact on the secondary current signal, so causing the occurrence of a prediction error peak. Generally speaking, a rapid change of phase and amplitude of the high-tension voltage does not necessarily imply saturation of the transformer.

It follows from the foregoing description that the prediction error does not in itself constitute a sufficient criterion for concluding with certainty that a current transformer is saturated.

In accordance with the invention, in order to detect saturation with certainty, a second saturation criterion must be applied in parallel with calculating the prediction error, and this second criterion must take account of the magnetic flux present in the secondary circuit of the current transformer.

As previously indicated, saturation of a transformer occurs if the absolute value of the real magnetic flux in the secondary circuit exceeds a maximum flux threshold Sₘₐₓ. The second saturation criterion would be sufficient in itself to conclude that saturation has occurred if the real flux and the maximum flux threshold could be determined accurately. However, in practice it is virtually impossible to determine them with sufficient reliability, as explained later.

With regard to the maximum flux threshold for a given transformer, its real value is not known accurately in the absence of a previous measurement. The specifications quoted by transformer manufacturers are systematically lower than the actual performance of the instruments, as a precaution, and can in some cases even be very much below their real performance. To this uncertainty is added the fact that the maximum flux threshold is proportional to the resistance R_{S} of the secondary circuit of the transformer, which resistance is not known accurately because it depends in particular on the secondary current measuring instruments connected to the secondary circuit.

Finally, as previously explained, the real flux is estimated with an uncertainty that is a function of the magnetic remanence characteristics of the current transformer, because of the uncertainty as to the real value of the remanent flux.

It follows from the foregoing description that the instantaneous difference between the real flux and the maximum flux threshold can be estimated only with a relatively large uncertainty. In the following description, high and low excursion margins for the real flux define the absolute value of the respective difference between an algebraic maximum of the estimated real flux and the maximum flux threshold and between an algebraic minimum of the estimated real flux and the minimum flux threshold. These high and low excursion margins are considered to be meaningful only in the absence of saturation. Thus the risk of saturation of the transformer increases as the high or low excursion margin decreases, and the limit of saturation is reached when that margin becomes zero. Because of the uncertainties mentioned above, the high or low excursion margin of the estimated real flux is too imprecise for a saturation phase to be recognized with certainty.

The above considerations are illustrated by concrete examples in FIGS. 4 to 6.

In FIG. 4, the sampled measurements of a secondary current signal is are represented superimposed on the correspond primary current signal Ip in a non-saturated regime of a current transformer. The secondary current signal is conventionally low-pass filtered to eliminate the harmonics therefrom. Note that the first sample is acquired at a time approximating 80 signal sampling periods, on a time scale with an arbitrary origin. At a given time marking the end of the non-saturated regime, a high symmetrical fault current is established in the primary circuit, considerably increasing the amplitude of the primary current Iₚ. The transformer enters a saturated regime, during which saturation phases are established for which the secondary currents is are highly distorted, compared to the primary current Iₚ.

In FIG. 5, the algebraic values of the measured instantaneous magnetic flux Φₘₑₛ(t) are calculated as the surface area of the secondary current i_{S} as a function of time multiplied by the secondary resistance R_{S}, as expressed by the following equation:

$${Φ}_{mes} ( t ) = {R}_{s} {\int }_{0}^{t} {i}_{s} ( t ) ⅆ t$$

In practice, the sampled values Yₖ of the secondary current are conventionally integrated using a first order digital integrator filter, which amounts to the same thing as using a so-called trapezium method represented by the following equation:

$${\int }_{0}^{t} {i}_{s} ( t ) ⅆ t ≅ {\sum }_{k = 1}^{N} ( {Y}_{k} + {Y}_{k - 1} ) \times {T}_{e} / 2$$

The samples Φₘₑₛ(k) of the measured flux can therefore be calculated:

$${Φ}_{mes} ( k ) = {R}_{s} {\sum }_{k = 1}^{N} ( {Y}_{k} + {Y}_{k - 1} ) \times {T}_{e} / 2$$

In the non-saturated regime, the curve of the measured flux Φₘₑₛ varies sinusoidally with the same fundamental period as the secondary current i_{S}, and has a phase-shift of π/2 relative to the curve for i_{S}. Note that the measured flux has a maximum or minimum when the current i_{S} passes through zero.

The figures shows that during the saturated regime of the transformer the measured flux has brief phases during which it remains substantially constant, whence a plateau shape for the maxima and minima of these fluxes. These phases approximately correspond to the real saturation pulses of the transformer, which are the pulses that must be determined accurately. Measuring the maximum and minimum plateaux of the flux defines equal and opposite saturation thresholds Sₘₐₓ and Sₘᵢₙ, so that any maximum or minimum of the flux has an absolute value greater than the threshold value Sₘₐₓ. For simplicity in the following description, as far as the commentary on FIG. 7, it is considered that the saturation thresholds Sₘₐₓ and Sₘᵢₙ substantially correspond to the real limits of the linearity of the response of the transformer.

As previously explained, the value of the remanent flux must be added to the measured flux to obtain the real flux. Given the uncertainty as the remanent flux, it is possible to define two extreme algebraic fluxes, respectively called the high flux and the low flux and designated Φ_high and Φ_low hereinafter, so as to be certain to bracket the real flux each time.

FIG. 6 shows the high and low extreme flux curves that bracket the real current flux in the absence of saturation. The high and low fluxes are calculated from the measured flux Φₘₑₛ, which is shown in FIG. 5, by adding to it the opposite extreme values that bracket the remanent flux:

$$\{ \begin{matrix}Φ\_high = {Φ}_{mes} + Φ\_rem \_high \\ Φ\_low = {Φ}_{mes} + Φ\_rem \_low\end{matrix}$$

The FIG. 6 example shows that the low excursion margin of the low flux, i.e. the absolute value of the difference between the negative saturation threshold Sₘᵢₙ and the minimum value of the low flux, is much smaller than the low excursion margin of the measured flux Φₘₑₛ. Accordingly, the hypothesis of a negative remanent flux equal to the extreme value Φ_rem_low amounts to the same thing as considerably increasing the risk of saturation, since a small increase in the amplitude of the secondary current is could be sufficient to increase the amplitude of the real flux until it crosses the negative saturation threshold. However, this hypothesis remains valid in this example because the low flux does not cross the negative saturation threshold in the absence of saturation.

Conversely, it is apparent that the high flux greatly exceeds the positive saturation threshold Sₘₐₓ, to the point of reaching a maximum for which the value of the excess flux relative to the threshold is designated ΔΦ+ in the figure. As it is not possible for the high flux to exceed this positive threshold Sₘₐₓ in the absence of saturation, this implies that the hypothesis of a positive remanent flux equal to the extreme value Φ_rem_high is unrealistic. The precaution of overestimating the positive upper limit of the remanent flux is therefore a posteriori excessive in this concrete instance.

The remanent flux must additionally be equal to a positive value Φ_rem_max such that the excursion margin of the estimated real flux is virtually zero, and similarly must be at the minimum equal to a negative value Φ_rem_min such that the low excursion margin of the estimated real flux is virtually zero. These two conditions imply that the overestimate effected a priori on the absolute value of the remanent flux may need to be corrected during the measurements of the flux, in such a fashion as to refine the estimate of the remanent flux by correcting one or both of the two limit values bracketing it.

This correction is effected only in the case of an excess of at least one of the extreme algebraic fluxes Φ_high and Φ_low relative to a saturation threshold Sₘₐₓ or Sₘᵢₙ. Just as ΔΦ+ designates the absolute value of a high flux excess relative to the positive threshold Sₘₐₓ, ΔΦ− hereinafter designates the absolute value of a low flux excess relative to the negative threshold Sₘᵢₙ. Defining a flux excess ΔΦ+ or ΔΦ− is meaningful only in the event of a high or low flux crossing a positive or negative saturation threshold. Nevertheless, for consistency in what follows, it is considered that a flux excess is defined as zero in the absence of crossing a saturation threshold.

FIG. 7 shows a method in accordance with the invention for refining the estimate of the remanent flux outside the saturation regime, which is equivalent to refining the estimate of the real flux. In practice, a non-saturated operating regime of the transformer is recognised by continuously verifying that the first saturation criterion based on calculating the prediction error is not satisfied. As previously explained, absence of saturation is certain if the prediction error on the secondary current signal has an absolute value less than a threshold close to zero.

Provided that this condition is verified, and subject to the additional condition of detecting an extreme flux excess (D high or Φ_low relative to a saturation threshold Sₘₐₓ or Sₘᵢₙ, algorithms for recognising maxima and minima of the measured flux are applied to the sampled values Φₘₑₛ(k) of the measured flux. The algorithms determine in real time a time corresponding to a high flux maximum or a low flux minimum, and among other things calculate the flux excess ΔΦ+ or ΔΦ− at that time.

In the situation shown in the figure, in which only the high flux must be corrected, the correction method used can be summarized by the following relationships:

$$\begin{matrix}• No saturation \\ • High flux excess , \\ i . e . Φ\_high > {S}_{max} \\ • Detect a maximum of the \\ measured flux ( and \\ therefore a maximum of \\ the high flux ) \end{matrix} \} ⇒ \{ \begin{matrix}CORRECTION \\ • compute flux excess \\ ΔΦ + \\ • compute corrected high \\ flux \text{:} \\ Φ\_max = Φ\_high - Δ Φ +\end{matrix}$$

The above method can of course be applied in an analogous fashion to correcting the low flux if it has a minimum below the negative saturation threshold Sₘᵢₙ. By computing the absolute value ΔΦ− of the low flux excess for this minimum, it is possible to define a corrected low flux Φ_min equal to the sum Φ_low+ΔΦ−.

Generally speaking, refining the real flux is reflected in the following relationships:

$$\{ \begin{matrix}Φ\_min < {Φ}_{real} < Φ\_max \\ with \vert Φ\_max = Φ\_high - Δ Φ + \\ \vert Φ\_min = Φ\_low + ΔΦ -\end{matrix}$$

Thus correcting the position of the high flux or the low flux relative to a respectively positive or negative saturation threshold is reflected in the calculation of a corrected high or low flux Φ_max or Φ_min, at least one maximum or minimum of which is tangential to the saturation threshold concerned, so as not to cross that threshold in the absence of saturation. Correcting the position of an extreme flux relative to a saturation threshold is therefore equivalent to assuming that the saturation limit of the estimated real flux is reached without being exceeded, i.e. that the high or low excursion margin of the estimated flux is reduced to zero.

As explained above, refining the estimate of the real flux amounts to correcting one or both of the two limit values that bracket the remanent flux. Φ_rem_max and Φ_rem_min designate the respective upper and lower corrected limits of the remanent flux, the indeterminate value of the latter being designated Φᵣₑₘ. Refining the remanent flux is reflected in the following relationships:

$$\{ \begin{matrix}Φ\_rem \_min < {Φ}_{rem} < Φ\_rem \_max \\ with \vert Φ\_rem \_max = Φ\_rem \_high - Δ Φ + \\ \vert Φ\_rem \_min = Φ\_rem \_low + ΔΦ -\end{matrix}$$

The algorithms for recognising maxima and minima of the measured flux for correcting the high flux or the low flux preferably verify the following relationships in the absence of saturation for three successive samples k−2, k−1 and k of the measured flux:

$$\begin{matrix}\{ \begin{matrix}Φ\_low ( k - 1 ) < {S}_{min} \\ {Φ}_{mes} ( k - 1 ) - {Φ}_{mes} ( k - 2 ) < 0\end{matrix} ⇒ \{ \begin{matrix}Φ\_low ( k - 1 ) is a minimum \\ of the low flux\end{matrix} & \\ {Φ}_{mes} ( k ) - {Φ}_{mes} ( k - 1 ) > 0 ΔΦ -= \vert Φ\_low ( k - 1 ) - {S}_{min} \vert & \\ and \text{/} or & \\ \{ \begin{matrix}Φ\_high ( k - 1 ) > {S}_{max} \\ {Φ}_{mes} ( k - 1 ) - {Φ}_{mes} ( k - 2 ) > 0\end{matrix} ⇒ \{ \begin{matrix}Φ\_high ( k - 1 ) is a maximum \\ of the high flux\end{matrix} & \\ {Φ}_{mes} ( k ) - {Φ}_{mes} ( k - 1 ) < 0 ΔΦ += Φ\_high ( k - 1 ) - {S}_{max} & \end{matrix}$$

As mentioned previously, in commenting on FIG. 5, the foregoing description considers the absolute value Sₘₐₓ of a saturation threshold, chosen empirically, to correspond substantially to the real limits of linearity of the response of the transformer. However, it has also been mentioned that the value Sₘₐₓ is not known precisely in the absence of previous measurements, and that its estimate is necessarily below the value corresponding to the real limits of the transformer.

Underestimating in this way the absolute value of a saturation threshold amounts to reducing the excursion margin of the estimated real flux, in a similar way to what happens when the absolute value of the remanent flux of the transformer is overestimated, which is equivalent to exaggerating the probability of the flux crossing the saturation threshold when beginning the measurement. It is therefore possible to satisfy the second saturation criterion that takes account of the magnetic flux, whereas the first saturation criterion based on the instantaneous prediction error is not satisfied. As previously explained, it is not realistic to observe the crossing of a saturation threshold if the first saturation criterion is not satisfied, since this condition implies an absence of any saturation phase.

Correcting the relative position of the high or low flux with respect to a saturation threshold means that a plausible hypothesis can be adopted whereby no threshold is crossed in the absence of saturation. This correction is pessimistic in terms of the risk of saturation, however, since the high and/or low excursion margin of the real flux is then estimated at zero.

The method that has just been described for comparing and correcting high and low fluxes with respect to the saturation thresholds, outside a saturation regime, can be simplified so as not to introduce these two extreme fluxes. Of course, the following simplified method is completely equivalent to the preceding method in terms of the starting and correction hypotheses adopted.

FIG. 8 shows the curve of the measured flux Φₘₑₛ as shown in FIG. 5, outside a saturation regime. The saturation thresholds Sₘₐₓ and Sₘᵢₙ previously defined are shown in dashed line. Referring to FIG. 6, it is clearly apparent that the high and low extreme fluxes can be compared to the saturation thresholds on the basis of only the measured flux, provided that reduced saturation thresholds are defined on the basis of the opposite thresholds Sₘₐₓ and Sₘᵢₙ. It is sufficient to reduce the absolute value Sₘₐₓ of these thresholds by subtracting therefrom the extreme positive value Φ_rem_high for the remanent flux.

As shown in FIGS. 8a and 8b, reduced saturation thresholds S+ and S− are defined as follows:

$$\{ \begin{matrix}S += {S}_{max} - Φ\_rem \_high \\ S -= {S}_{min} - Φ\_rem \_low\end{matrix}$$

Note, for example that the position of the high flux Φ_high relative to the saturation Sₘₐₓ is equivalent to that of the measured flux Φₘₑₛ relative to the reduced saturation threshold S+, and in particular that the high flux excess ΔΦ+ is also calculated as an excess of the measured flux Φₘₑₛ compared to the reduced threshold S+.

As for the corrected high flux in FIG. 7, the position of the measured flux relative to the reduced positive saturation threshold S+ is corrected because this threshold is crossed by the flux in the absence of saturation. The two correction methods explained are therefore equivalent. In particular, they amount to the same thing as reducing at least the absolute value of an extreme value of the remanent flux. In the example shown, the correction is equivalent to reducing the positive value Φ_rem_high because that value is excessive by a flux quantity ΔΦ+ that can be determined using one or other of these methods.

In an analogous manner to the first correction method shown in FIG. 7, this method for correcting the relative position of the measured flux with respect to a positive or negative saturation threshold is reflected in the calculation of a respective corrected flux Fₘₐₓ or Fₘᵢₙ, at least one maximum or minimum of which is tangential to the saturation threshold concerned. This calculation is summarized by the following equations:

$$\{ \begin{matrix}{F}_{max} = {Φ}_{mes} - Δ Φ + \\ {F}_{min} = {Φ}_{mes} + Δ Φ -\end{matrix}$$

The algorithms for recognising maxima and minima of the measured fluxes are preferably analogous to those described for the first correction method.

From the two equivalent methods described previously, it is clear that this processing corrects the relative position of one flux relative to a saturation threshold. It is then possible to refer to mutual adaptation of a flux and a threshold. In the preceding examples, it was considered that the saturation thresholds Sₘₐₓ and Sₘᵢₙ or S+ and S− were fixed on starting the measurement, and that a flux correction consisted in adapting the flux to a threshold that remained fixed.

Without departing from the scope of the invention, it is equally possible to correct the position of a threshold relative to the measured flux in the absence of saturation, so as to match the threshold and the measured flux to each other to obtain a result equivalent to that obtained with the preceding methods. For example, in FIG. 8a, the threshold S+ fixed at the beginning of the measurement can be increased to match it to the measured flux. Rather than reducing the measured flux to render it tangential to the fixed threshold S+, it is possible to define a corrected positive threshold S′+ by increasing the threshold S+ by the excess flux quantity ΔΦ+, which is reflected in the following equation:
S′+=Sₘₐₓ−Φ_{—}rem_{—}high+ΔΦ+.

This corrected positive threshold can be compared to the measured flux to establish if the second saturation criterion is satisfied. In a similar manner, it is possible to define a corrected negative threshold
S′−=Sₘᵢₙ−Φ_{—}rem_{—}low+ΔΦ−,
which can have a different absolute value than the threshold S′+. Clearly it is not necessary in this case to define two fluxes Fₘₐₓ and Fₘᵢₙ, since only the measured flux has to be compared to the corrected thresholds S′+ and S′− to apply the second saturation criterion.

In FIG. 9, the first two curves simultaneously represent the sampled measurements Yₖ of a secondary current signal i_{S} which is saturated and a prediction curve ε(Yₖ) obtained from these measurements using the mathematical model illustrated in FIG. 3. It is found that the prediction error curve has very narrow positive and negative spikes.

As previously explained, absence of saturation is certain if the prediction error has an absolute value less than a threshold close to zero. The curve ε(Yₖ) shows that it is difficult to fix a threshold enabling phases of non-saturation of the transformer to be defined reliably, because of the narrow spikes of the signal. There is a high risk of obtaining non-saturation phases that are too long compared to the real-saturated phases, for which the signal is quasi-sinusoidal. To be able to define a threshold for determining the phases of non-saturation, and conversely the phases of distortion of the signal, in a more refined way, it is desirable in practice to smooth the prediction error.

This smoothing preferably consists in calculating a relative prediction error, of positive sign, defined as the ratio between the standard deviation σ|ε(Y)| of the absolute value of the instantaneous prediction error and the standard deviation σ|Y| of the absolute value of the measured current, with a standard deviation possibly weighted by a coefficient or by an exponential function. A standard deviation is defined as the square root of the variance, which is defined as the arithmetic mean of the mean square errors. In practice, calculating a standard deviation for an instantaneous prediction error ε(Yₖ) takes account of the standard deviation calculated for the instantaneous prediction error ε(Yₖ₋₁) of the preceding current sample. To estimate the arithmetic mean, a first order recurrent digital filter is preferably used over a sliding window that brackets a significant given number of samples. Of course, the prediction error signal could be smoothed by any other appropriate calculation method, without departing from the scope of the invention.

On the curve obtained by this calculation, it can be seen that the signal has been very significantly smoothed relative to the prediction error signal, and therefore no longer has any narrow spikes. The distortion phases of the secondary current signal is are characterized by humps in the relative prediction error signal, which humps are much wider than the corresponding spikes of the prediction error signal.

It is therefore possible to fix empirically a positive threshold S₀ for reliably defining non-saturation phases of the transformer and phases during which real saturation of the transformer is highly probable. The first saturation criterion, designated C_{ε sat} in FIG. 9 and the subsequent figures, is satisfied as soon as the relative prediction error is greater than this threshold. This condition is represented in FIG. 9 by logic signals designated by the event “C_{ε sat}=1”.

According to the invention, this first saturation criterion that takes account of the calculation of an instantaneous prediction error must be associated with the second saturation criterion that takes account of the calculation of the algebraic flux, in order to detect a phase of saturation of the transformer when these criteria are satisfied simultaneously. The method of associating these two criteria is summarized in the FIG. 10 logic diagram.

In FIG. 10, εᵣ designates the relative prediction error calculated as in the FIG. 9 example. Similarly, C_{Φsat} designates the second saturation criterion and “C_{Φsat}=1” the event corresponding to the crossing of at least one positive or negative saturation threshold by a calculated flux. Referring to FIGS. 8, 8a and 8b, it is clear that the event “C_{Φsat}=1” corresponds for this example to the logic condition “(Fₘₐₓ>S+) OR (Fₘᵢₙ<S−)”.

FIGS. 11 and 12 show concrete examples of application of the saturation detection method according to the invention.

In FIG. 11, a first window represents the curve of the sampled secondary current signal is of a transformer changing from a normal regime to a saturated regime. The first sample is acquired at a time t₀. The fundamental period of the primary current is 50 Hz, and here the change to the saturated regime is brought about by an eightfold increase in the amplitude of this current. Also, it is assumed that an aperiodic component appears in the primary current with a time constant equal to 60 ms.

A second window represents the relative prediction error curve Er calculated as indicated in the FIG. 9 example. A threshold S₀ corresponding to a relative error percentage close to zero is defined empirically.

A third window represents the curve of the measured flux Φₘₑₛ calculated by integrating the secondary current, as explained in FIG. 5. Because the current is has just begun a negative half-wave just before time t₀, it is logical that the calculation by integration produces a curve Φₘₑₛ for which most of the values are negative. A positive saturation threshold S+ is fixed on starting the measurement and satisfies the equation S+=Sₘₐₓ−Φ_rem_high, as in the FIG. 8a example. In practice, an estimate of the maximum remanent flux Φ_rem_high of the transformer can be obtained from a knowledge of its class. In this example, it is assumed that the transformer is of the TPY class, which means that Φ_rem_high=20%×S+max. From this it is deduced that S+=80%×Sₘₐₓ. Symmetrically, for the negative saturation threshold S−: S−=−80%×Sₘₐₓ.

Accordingly, for a transformer of a given class, the saturation thresholds S+ and S− are fixed on beginning the measurement, on condition that it is possible to supply the processing system with an estimate of the saturation threshold Sₘₐₓ beyond which the linearity of the response of the transformer is no longer assured.

The method chosen here for matching the flux and the positive threshold has the threshold S+ remained fixed during processing. The same applies to the threshold S− discussed later. In the FIG. 11 example, unlike that shown in FIG. 8a, there is not need to match the measured flux to the positive threshold because it does not cross that threshold provided that the absence of saturation condition is satisfied: εᵣ<S₀. The fact that the measured flux is not matched is simply reflected in the following equation: Fₘₐₓ=Φₘₑₛ.

From this curve, saturation pulses corresponding to so-called positive saturation of the transformer can be determined as soon as the measured flux exceeds the positive threshold. The first two positive saturation pulses are shown cross-hatched in a fourth window of the figure, and correspond to simultaneous satisfaction of the following two saturation criteria:

$$\{ \begin{matrix}{F}_{max} > S + \\ {ɛ}_{r} > {S}_{0}\end{matrix}$$

The first pulse occurs at a time t_{S} that marks the beginning of the saturation regime, and ends at a time tₚₑ which marks the beginning of a short phase of non-saturation during which the protection system is authorized to use the measurements of the current provided by the transformer, despite the saturated regime of the transformer.

A fifth window shows firstly the curve of the measured flux Φₘₑₛ and the negative saturation threshold S− fixed on starting the measurement, the latter satisfying the equation s−=Sₘᵢₙ=Φ_rem_low as in the FIG. 8b example. Unlike what is shown in FIG. 8b, here the measured flux needs to be matched to the negative threshold because it crosses that threshold at least once while the condition εᵣ<S₀ is simultaneously verified.

Using the method previously indicated, the sample corresponding to the first minimum of the measured flux is detected around fifteen sampling periods after the time to marking the start of the measurement, and it is found that this minimum is below the threshold S− while the condition εᵣ<S₀ is simultaneously verified. The absolute value ΔΦ− of the flux excess is then calculated, enabling a corrected flux Fₘᵢₙ to be determined that satisfies the following equation:
Fₘᵢₙ=Φₘₑₛ+ΔΦ−

The curve of this corrected flux is shown in thick line in the fifth window. Saturation pulses corresponding to so-called negative saturation of the transformer can be determined from this curve as soon as the corrected flux is below the negative threshold S−. The first two negative saturation pulses are shown cross-hatched in a sixth window in the figure, and correspond to simultaneous satisfaction of the following two saturation criteria:

$$\{ \begin{matrix}{F}_{min} < S - \\ {ɛ}_{r} > {S}_{0}\end{matrix}$$

The first negative saturation pulse occurs at a time tₚₑ+δ and marks the end of the first phase of non-saturation that follows the first positive saturation pulse, the value δ corresponding to the short duration of that non-saturation phase.

By observing all the positive and negative saturation pulses, it is seen that the saturated regime of the transformer is interleaved with short phases of non-saturation. Furthermore, the saturation pulses each have a duration that is less than the fundamental period of the primary current, here with the exception of the first pulse. As emphasized in the introduction, it is important for the duration of a pulse to be as short as possible, and in particular for it to remain less than the fundamental period of the current. This condition reflects the necessity of being able to trip the protection system associated with the transformer as quickly as possible in the event of a fault internal to the area monitored by the system, including when saturation of the transformer occurs while the internal fault is present.

In the particular example of FIG. 11, it can be seen that the saturation detection method according to the invention generates an erroneous saturation pulse just before the measured flux is matched to the negative threshold. The logic condition “(Φₘₑₛ<S−) AND (εᵣ>S₀)” is verified here during a very short time period at the start of the measurement, although there is no real saturation of the transformer at that time. Because of its very short duration compared to the fundamental period of the current, this erroneous pulse has no harmful effect on the operation of the protection system.

In this example, the fact that the duration of the first saturation pulse exceeds that of the fundamental period of the current is caused by the relatively long time constant of the aperiodic component that appears in the primary current. A time constant equal here to 60 ms is much greater than the 20 ms of the fundamental period of a 50 Hz current. This represents an unfavourable situation tending to reduce the performance of the protection system in the event of a fault internal to its surveillance area during the first saturation pulse.

With a shorter time constant, the average duration of the first saturation pulses tends to decrease, in particular the duration of the first pulse.

FIG. 12 shows graphically a more favourable example than the preceding one for implementation of the method according to the invention to determine saturation pulses of a saturated regime of the transformer. It is assumed that the same current transformer is used, and that the primary current with no saturation is the same as in the FIG. 11 example. It is also assumed that the change to the saturated regime is caused by an eightfold increase in the amplitude of the current. However, it is considered here that there is no aperiodic component in the primary current, which amounts to stating that the time constant is zero. The opposite saturation thresholds S+ and S− correspond to those of the preceding example.

Because the secondary current has just begun a positive half-wave just before the acquisition of the first sample, it is logical for the integration calculation to produce a Φₘₑₛ curve for which most values are positive. As in the example shown in FIG. 8a, the measured flux must here be matched to the positive saturation threshold S+ and remain unchanged in order to be compared to the negative saturation threshold S−.

The saturation pulses are determined in the same manner as explained in the preceding example, and are shown in a fourth window of FIG. 12. It can be seen that the first pulse, which occurs at a time t_{S} marking the start of the saturation regime, is of very much shorter duration than that observed in the preceding example, and less than the fundamental period of the current. Each of the other saturation pulses has a duration less than that of the first.

On average, the period δ of a non-saturation phase is comparable to that found in the preceding example. In both these examples, during each phase of non-saturation in the saturated regime, the protection system can process a few sampled measurements of the secondary current to locate a fault internal to the surveillance area.

1. A method of detecting saturation in a current transformer, based on associating at least two saturation criteria for detecting a saturation phase when said criteria are satisfied simultaneously, using digital processing of samples obtained by measuring and low-pass filtering the secondary current of the transformer to eliminate the harmonics therefrom, which transformer is subject to a remanent flux of indeterminate positive or negative value, wherein a first saturation criterion takes account of the calculation of an instantaneous prediction error which is a function of the difference between the measured secondary current and the secondary current predicted with the aid of a mathematical model, wherein a second saturation criterion takes account of the instantaneous algebraic flux calculated by integrating the sampled secondary current, comparing said algebraic flux to a positive threshold and to a negative threshold, and wherein said comparison is initialized with exaggerated probabilities of satisfying said second saturation criterion at the start of the measurement, in particular by overestimating the absolute value of the remanent flux of the transformer.

2. A saturation detection method according to claim 1, wherein a relative prediction error is calculated by establishing the ratio between the standard deviation of the absolute value of the instantaneous prediction error σ|ε(Y)| and the standard deviation of the absolute value of the measured current σ|Y|, and wherein the first saturation criterion is satisfied as soon as said relative prediction error is greater than a given percentage.

3. A saturation detection method according to claim 1, wherein the relative position of the algebraic flux with respect to a positive threshold and/or a negative threshold is corrected if said threshold is crossed by the algebraic flux in the absence of saturation, said correction consisting in particular of reducing at least the absolute value of an extreme value of the remanent flux, and wherein a saturation phase is established if at least one of said thresholds is crossed by the algebraic flux while the first saturation criterion is simultaneously satisfied.

4. A saturation detection method according to claim 3, wherein a positive threshold and a negative threshold are maintained constant throughout the method, and wherein the correction of the relative position of the algebraic flux with respect to one of said thresholds is reflected in the calculation of a corrected flux, at least one maximum or minimum of which is tangential to said threshold so as not to cross it in the absence of saturation.

5. A saturation detection method according to claim 1, wherein the mathematical model used to calculate the predicted secondary current is a second order auto-regressive sinusoidal model with fixed coefficients such that the value of the predicted current signal for a sample k depends on the value of the measured signal for the sample k−1 and the value of the measured signal for the sample k−2.

6. A saturation detection method according to claim 1, wherein the positive threshold and the negative threshold are chosen to be opposite and are determined by assuming that the absolute value of the remanent flux of the transformer is equal to a particular percentage of a maximum value of the flux beyond which the linearity of the response of the current transformer is not assured.

7. A saturation detection method according to claim 1, wherein the secondary current is integrated with the aid of a first order digital integrator filter.
